(19) United States
(12) Patent Application Publication
(10) Pub. No.: US 2026/0268413 A1
(43) Pub. Date: Sep. 10, 2026

(54) METHODS AND SYSTEMS FOR INSTANTIATING ARCHITECTURE FOR A TECHNICAL SERVICE OFFERING

(71) Applicant: Express Scripts Strategic Development, Inc., St. Louis, MO (US)

(72) Inventors: Paimon Sorornejad, South Windsor, CT (US); Michelle Zaremskas, Daytona Beach Shores, FL (US); James S. Wernicki, Plantsville, CT (US); Zachary P. Curtin, Feeding Hills, MA (US)

(21) Appl. No.: 19/075,054

(22) Filed: Mar. 10, 2025

(51) Int. Cl. G06Q 40/08

(52) U.S. Cl. CPC G06Q 40/08

(57) ABSTRACT

Methods and systems for systems for instantiating architecture for a technical service offering. In one embodiment, a packaging subsystem receives a request for a technical service offering, creates an infrastructure service instance (“ISI”) data object associated with the technical service offering, communicating with an object management subsystem to determine available infrastructure assets monitored by the object management subsystem, creating at least one infrastructure instance specified by the at least one infrastructure object of the ISI data object, and storing the ISI data object in a configuration management data base (“CMDB”).

### FIELD

The present disclosure relates generally to the technical field of information technology service offerings. In a specific example, the present disclosure may relate to using a data object to group all infrastructure objects that instantiate an instance of an information technology technical service offering.

### BACKGROUND

Information systems and operations management (“ISOM”) or information technologies service management (“ITSM”) are strategic approaches to manage IT services and operations. ITSM or ISOM typically define how to manage end-to-end delivery of IT services to IT consumers, whether within an organization or to external customers. Generally, these IT services are created on-demand and in response to a request by an IT consumer. For example, a request for a mainframe with a certain service level objective (“SLO”), such as 99% guaranteed uptime, requires IT personnel to stand up the mainframe, determine the number of network paths to meet the SLO, make those network connections to the stood up mainframe, determine any additional hardware resiliencies, determine the number of redundant regions for the mainframe to meet the SLO, and define all the infrastructure items necessary to provide the requested service. The time necessary to meet these service offerings can be significant and may not always meet defined service level agreements (“SLA”). Providing service offerings on a workflow management platform further exasperates these issues.

### BRIEF DESCRIPTION OF THE DRAWINGS

FIG. 1 is a functional block diagram of an example system including a high-volume pharmacy.

FIG. 2 is a functional block diagram of an example pharmacy fulfillment device, which may be deployed within the system of FIG. 1.

FIG. 3 is a functional block diagram of an example order processing device, which may be deployed within the system of FIG. 1.

FIG. 4 is a block diagram of an example benefit manager device that may be deployed within the system of FIG. 1, according to an example embodiment;

FIGS. 5A and 5B are block diagrams of an infrastructure service instance data object, according to example embodiments; and

FIG. 6 is a block diagram of a flowchart illustrating methods for automating the creation of a technical service offering using an infrastructure service instance data object, according to an example embodiment.

### DETAILED DESCRIPTION

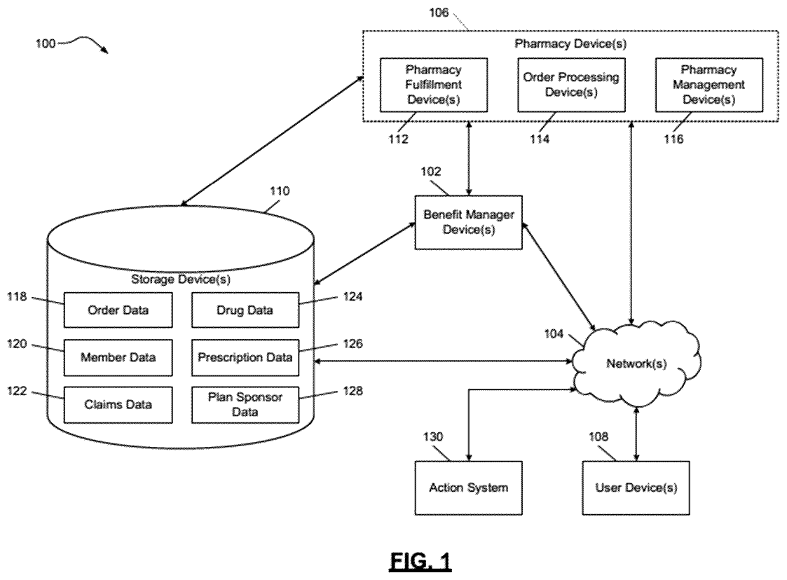

FIG. 1 is a block diagram of an example implementation of a system 100 for a high-volume pharmacy. While the system 100 is generally described as being deployed in a high-volume pharmacy or a fulfillment center (for example, a mail order pharmacy, a direct delivery pharmacy, etc.), the system 100 and/or components of the system 100 may otherwise be deployed (for example, in a lower-volume pharmacy, etc.). A high-volume pharmacy may be a pharmacy that is capable of filling at least some prescriptions mechanically. The system 100 may include a benefit manager device 102 and a pharmacy device 106 in communication with each other directly and/or over a network 104. The system 100 may also include a storage device 110.

The benefit manager device 102 is a device operated by an entity that is at least partially responsible for creation and/or management of the pharmacy or drug benefit. While the entity operating the benefit manager device 102 is typically a pharmacy benefit manager (PBM), other entities may operate the benefit manager device 102 on behalf of themselves or other entities (such as PBMs). For example, the benefit manager device 102 may be operated by a health plan, a retail pharmacy chain, a drug wholesaler, a data analytics or other type of software-related company, etc. In some implementations, a PBM that provides the pharmacy benefit may provide one or more additional benefits including a medical or health benefit, a dental benefit, a vision benefit, a wellness benefit, a radiology benefit, a pet care benefit, an insurance benefit, a long-term care benefit, a nursing home benefit, etc. The PBM may, in addition to its PBM operations, operate one or more pharmacies. The pharmacies may be retail pharmacies, mail order pharmacies, etc.

Some of the operations of the PBM that operates the benefit manager device 102 may include the following activities and processes. A member (or a person on behalf of the member) of a pharmacy benefit plan may obtain a prescription from a physician, and the member may seek to receive a prescription drug from a pharmacy. The prescription drug may require prior authorization and/or renewal from a health plan provider prior to dispensing the drug, and the PBM may request prior authorization or renewal. Upon receiving authorization or renewal approval, the member may obtain the prescription drug. The member may also obtain the prescription drug through mail order drug delivery from a mail order pharmacy location, such as the system 100. In some implementations, the member may obtain the prescription drug directly or indirectly through the use of a machine, such as a kiosk, a vending unit, a mobile electronic device 108, or a different type of mechanical device, electrical device, electronic communication device, and/or computing device. Such a machine may be filled with the prescription drug in prescription packaging, which may include multiple prescription components, by the system 100. The pharmacy benefit plan is administered by or through the benefit manager device 102.

The member may have a copayment for the prescription drug that reflects an amount of money that the member is responsible to pay the pharmacy for the prescription drug. The money paid by the member to the pharmacy may come from, as examples, personal funds of the member, a health savings account (HSA) of the member or the member's family, a health reimbursement arrangement (HRA) of the member or the member's family, or a flexible spending account (FSA) of the member or the member's family. In some instances, an employer of the member may directly or indirectly fund or reimburse the member for the copayments.

The amount of the copayment required by the member may vary across different pharmacy benefit plans having different plan sponsors or clients and/or for different prescription drugs. The member's copayment may be a flat copayment (in one example, $10), coinsurance (in one example, 10%), and/or a deductible (for example, responsibility for the first $500 of annual prescription drug expense, etc.) for certain prescription drugs, certain types and/or classes of prescription drugs, and/or all prescription drugs. The copayment may be stored in the storage device 110 or determined by the benefit manager device 102.

In some instances, the member may not pay the copayment or may only pay a portion of the copayment for the prescription drug. For example, if a usual and customary cost for a generic version of a prescription drug is $4, and the member's flat copayment is $20 for the prescription drug, the member may only need to pay $4 to receive the prescription drug. In another example involving a worker's compensation claim, no copayment may be due by the member for the prescription drug.

In addition, copayments may also vary based on different delivery channels for the prescription drug. For example, the copayment for receiving the prescription drug from a mail order pharmacy location may be less than the copayment for receiving the prescription drug from a retail pharmacy location.

In conjunction with receiving a copayment (if any) from the member, receiving authorization approval, and dispensing the prescription drug to the member, the pharmacy submits a claim to the PBM for the prescription drug, which may require prior authorization or renewal. After receiving the claim, the PBM (such as by using the benefit manager device 102) may perform certain adjudication operations including verifying eligibility for the member, identifying/reviewing an applicable formulary for the member to determine any appropriate copayment, coinsurance, and deductible for the prescription drug, and performing a drug utilization review (DUR) for the member. The PBM may also perform automatic prior authorization or make renewal decisions with the claim submission, which may include determining whether to cover some or all of the costs related to dispensing the prescription drug, determining whether any cheaper alternative drugs may substitute for the prescription drug, determining whether the member can afford the costs to receive the prescription drug, and negotiating a lower price for the prescription drug on behalf of the member when the member cannot afford the full-price of the prescription drug. Further, the PBM may provide a response to the pharmacy (for example, the pharmacy system 100) following performance of at least some of the aforementioned operations, which many include approval or denial of the claim as a result of performing prior authorization or renewal decisions.

As part of the adjudication, a plan sponsor (or the PBM on behalf of the plan sponsor) ultimately reimburses the pharmacy for filling the prescription drug when the prescription drug was successfully adjudicated. The aforementioned adjudication operations generally occur before the copayment is received and the prescription drug is dispensed.

However in some instances, these operations may occur simultaneously, substantially simultaneously, or in a different order. In addition, more or fewer adjudication operations may be performed as at least part of the adjudication process.

The amount of reimbursement paid to the pharmacy by a plan sponsor and/or money paid by the member may be determined at least partially based on types of pharmacy networks in which the pharmacy is included. In some implementations, the amount may also be determined based on other factors. For example, if the member pays the pharmacy for the prescription drug without using the prescription or drug benefit provided by the PBM, the amount of money paid by the member may be higher than when the member uses the prescription or drug benefit. In some implementations, the amount of money received by the pharmacy for dispensing the prescription drug and for the prescription drug itself may be higher than when the member uses the prescription or drug benefit. Some or all of the foregoing operations may be performed by executing instructions stored in the benefit manager device 102 and/or an additional device.

Examples of the network 104 include a Global System for Mobile Communications (GSM) network, a code division multiple access (CDMA) network, 3rd Generation Partnership Project (3GPP), an Internet Protocol (IP) network, a Wireless Application Protocol (WAP) network, or an IEEE 802.11 standards network, as well as various combinations of the above networks. The network 104 may include an optical network. The network 104 may be a local area network or a global communication network, such as the Internet. In some implementations, the network 104 may include a network dedicated to prescription orders: a prescribing network such as the electronic prescribing network operated by Surescripts of Arlington, Virginia.

Moreover, although the system shows a single network 104, multiple networks can be used. The multiple networks may communicate in series and/or parallel with each other to link the devices 102-110.

The pharmacy device 106 may be a device associated with a retail pharmacy location (e.g., an exclusive pharmacy location, a grocery store with a retail pharmacy, or a general sales store with a retail pharmacy) or other type of pharmacy location at which a member attempts to obtain a prescription. The pharmacy may use the pharmacy device 106 to submit the claim to the PBM for adjudication.

Additionally, in some implementations, the pharmacy device 106 may enable information exchange between the pharmacy and the PBM. For example, this may allow the sharing of member information such as drug history that may allow the pharmacy to better service a member (for example, by providing more informed therapy consultation and drug interaction information). In some implementations, the benefit manager device 102 may track prescription drug fulfillment and/or other information for users that are not members, or have not identified themselves as members, at the time (or in conjunction with the time) in which they seek to have a prescription filled at a pharmacy.

The pharmacy device 106 may include a pharmacy fulfillment device 112, an order processing device 114, and a pharmacy management device 116 in communication with each other directly and/or over the network 104. The order processing device 114 may receive information regarding filling prescriptions and may direct an order component to one or more devices of the pharmacy fulfillment device 112 at a pharmacy. The pharmacy fulfillment device 112 may fulfill, dispense, aggregate, and/or pack the order components of the prescription drugs in accordance with one or more prescription orders directed by the order processing device 114.

In general, the order processing device 114 is a device located within or otherwise associated with the pharmacy to enable the pharmacy fulfilment device 112 to fulfill a prescription and dispense prescription drugs. In some implementations, the order processing device 114 may be an external order processing device separate from the pharmacy and in communication with other devices located within the pharmacy.

For example, the external order processing device may communicate with an internal pharmacy order processing device and/or other devices located within the system 100. In some implementations, the external order processing device may have limited functionality (e.g., as operated by a user requesting fulfillment of a prescription drug), while the internal pharmacy order processing device may have greater functionality (e.g., as operated by a pharmacist).

The order processing device 114 may track the prescription order as it is fulfilled by the pharmacy fulfillment device 112. The prescription order may include one or more prescription drugs to be filled by the pharmacy. The order processing device 114 may make pharmacy routing decisions and/or order consolidation decisions for the particular prescription order. The pharmacy routing decisions include what device(s) in the pharmacy are responsible for filling or otherwise handling certain portions of the prescription order. The order consolidation decisions include whether portions of one prescription order or multiple prescription orders should be shipped together for a user or a user family. The order processing device 114 may also track and/or schedule literature or paperwork associated with each prescription order or multiple prescription orders that are being shipped together. In some implementations, the order processing device 114 may operate in combination with the pharmacy management device 116.

The order processing device 114 may include circuitry, a processor, a memory to store data and instructions, and communication functionality. The order processing device 114 is dedicated to performing processes, methods, and/or instructions described in this application.

Other types of electronic devices may also be used that are specifically configured to implement the processes, methods, and/or instructions described in further detail below.

In some implementations, at least some functionality of the order processing device 114 may be included in the pharmacy management device 116. The order processing device 114 may be in a client-server relationship with the pharmacy management device 116, in a peer-to-peer relationship with the pharmacy management device 116, or in a different type of relationship with the pharmacy management device 116. The order processing device 114 and/or the pharmacy management device 116 may communicate directly (for example, such as by using a local storage) and/or through the network 104 (such as by using a cloud storage configuration, software as a service, etc.) with the storage device 110.

The storage device 110 may include: non-transitory storage (for example, memory, hard disk, CD-ROM, etc.) in communication with the benefit manager device 102 and/or the pharmacy device 106 directly and/or over the network 104. The non-transitory storage may store order data 118, member data 120, claims data 122, drug data 124, prescription data 126, and/or plan sponsor data 128. Further, the system 100 may include additional devices, which may communicate with each other directly or over the network 104.

The order data 118 may be related to a prescription order. The order data may include type of the prescription drug (for example, drug name and strength) and quantity of the prescription drug. The order data 118 may also include data used for completion of the prescription, such as prescription materials. In general, prescription materials include an electronic copy of information regarding the prescription drug for inclusion with or otherwise in conjunction with the fulfilled prescription. The prescription materials may include electronic information regarding drug interaction warnings, recommended usage, possible side effects, expiration date, date of prescribing, etc. The order data 118 may be used by a high-volume fulfillment center to fulfill a pharmacy order.

In some implementations, the order data 118 includes verification information associated with fulfillment of the prescription in the pharmacy. For example, the order data 118 may include videos and/or images taken of (i) the prescription drug prior to dispensing, during dispensing, and/or after dispensing, (ii) the prescription container (for example, a prescription container and sealing lid, prescription packaging, etc.) used to contain the prescription drug prior to dispensing, during dispensing, and/or after dispensing, (iii) the packaging and/or packaging materials used to ship or otherwise deliver the prescription drug prior to dispensing, during dispensing, and/or after dispensing, and/or (iv) the fulfillment process within the pharmacy.

Other types of verification information such as barcode data read from pallets, bins, trays, or carts used to transport prescriptions within the pharmacy may also be stored as order data 118.

The member data 120 includes information regarding the members associated with the PBM. The information stored as member data 120 may include personal information, personal health information, protected health information, etc. Examples of the member data 120 include name, address, telephone number, e-mail address, prescription drug history, etc. The member data 120 may include a plan sponsor identifier that identifies the plan sponsor associated with the member and/or a member identifier that identifies the member to the plan sponsor. The member data 120 may include a member identifier that identifies the plan sponsor associated with the user and/or a user identifier that identifies the user to the plan sponsor. The member data 120 may also include dispensation preferences such as type of label, type of cap, message preferences, language preferences, etc.

The member data 120 may be accessed by various devices in the pharmacy (for example, the high-volume fulfillment center, etc.) to obtain information used for fulfillment and shipping of prescription orders. In some implementations, an external order processing device operated by or on behalf of a member may have access to at least a portion of the member data 120 for review, verification, or other purposes.

In some implementations, the member data 120 may include information for persons who are users of the pharmacy but are not members in the pharmacy benefit plan being provided by the PBM. For example, these users may obtain drugs directly from the pharmacy, through a private label service offered by the pharmacy, the high-volume fulfillment center, or otherwise. In general, the use of the terms “member” and “user” may be used interchangeably.

The claims data 122 includes information regarding pharmacy claims adjudicated by the PBM under a drug benefit program provided by the PBM for one or more plan sponsors. In general, the claims data 122 includes an identification of the client that sponsors the drug benefit program under which the claim is made, and/or the member that purchased the prescription drug giving rise to the claim, the prescription drug that was filled by the pharmacy (e.g., the national drug code number, etc.), the dispensing date, generic indicator, generic product identifier (GPI) number, medication class, the cost of the prescription drug provided under the drug benefit program, the copayment/coinsurance amount, rebate information, and/or member eligibility, etc. Additional information may be included.

In some implementations, other types of claims beyond prescription drug claims may be stored in the claims data 122. For example, medical claims, dental claims, wellness claims, or other types of health-care-related claims for members may be stored as a portion of the claims data 122.

In some implementations, the claims data 122 includes claims that identify the members with whom the claims are associated. Additionally or alternatively, the claims data 122 may include claims that have been de-identified (that is, associated with a unique identifier but not with a particular, identifiable member).

The drug data 124 may include drug name (e.g., technical name and/or common name), other names by which the drug is known, active ingredients, an image of the drug (such as in pill form), etc. The drug data 124 may include information associated with a single medication or multiple medications. The drug data 124 may further include an indicator specifying whether prior authorization is required before dispensing each drug. The drug data 124 may further include a period of time before the prior authorization expires for each drug.

The prescription data 126 may include information regarding prescriptions that may be issued by prescribers on behalf of users, who may be members of the pharmacy benefit plan—for example, to be filled by a pharmacy. Examples of the prescription data 126 include user names, medication or treatment (such as lab tests), dosing information, etc. The prescriptions may include electronic prescriptions or paper prescriptions that have been scanned. In some implementations, the dosing information reflects a frequency of use (e.g., once a day, twice a day, before each meal, etc.) and a duration of use (e.g., a few days, a week, a few weeks, a month, etc.).

In some implementations, the order data 118 may be linked to associated member data 120, claims data 122, drug data 124, and/or prescription data 126.

The plan sponsor data 128 includes information regarding the plan sponsors of the PBM. Examples of the plan sponsor data 128 include company name, company address, contact name, contact telephone number, contact e-mail address, etc.

The system 100 illustrated in FIG. 1 can included various infrastructure elements, including networks, network paths, servers, databases, enterprise applications, processors, etc. The various infrastructure elements are either illustrated in FIG. 1 (e.g., the benefit manager device 102, the network 104, the storage device 110) or included as unillustrated sub-components of the system components illustrated in FIG. 1, as would be understood by those having skill in the art. A configuration management database (“CMBD”) can store all the various infrastructure elements as configuration items, and the storage device 110 may store the CMDB. The CMDB may also store relationships between the configuration items. The CMBD may store all of the configuration items included within the system 100 illustrated in FIG. 1.

The various infrastructure elements may be packaged together and sold as a technical service offering. A technical service offering is a technology offered to members of an organization or sold as a service to external customers. A technical service offering can include localization/geography, environment, pricing, availability, capability, support group (for incident), assignment group (for change), technical approval group (for change), and packaging options (commitments). A technical service offering consists of one or more service commitments that can define a level of service in terms of availability, criticality, scope, pricing, and other factors. The technical service offering can include the technical service (e.g., redis cache, mainframe, compute, a real application cluster, or other database architectures).

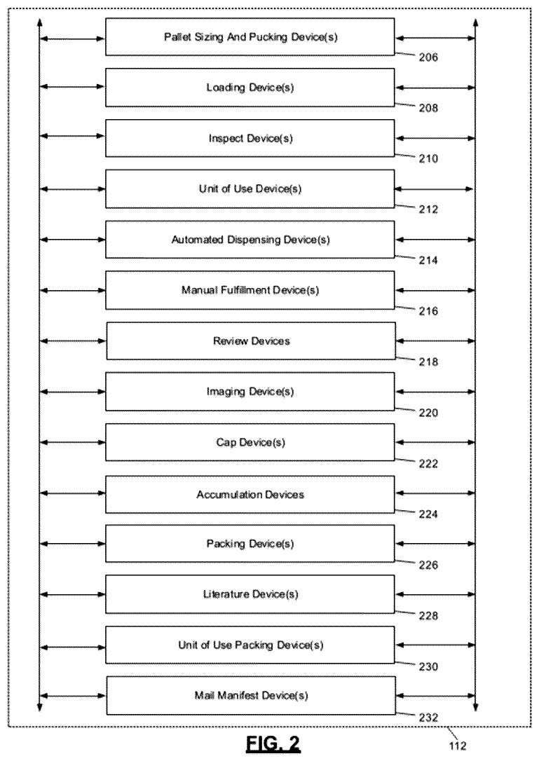

FIG. 2 illustrates the pharmacy fulfillment device 112 according to an example implementation. The pharmacy fulfillment device 112 may be used to process and fulfill prescriptions and prescription orders. After fulfillment, the fulfilled prescriptions are packed for shipping.

The pharmacy fulfillment device 112 may include devices in communication with the benefit manager device 102, the order processing device 114, and/or the storage device 110, directly or over the network 104. Specifically, the pharmacy fulfillment device 112 may include pallet sizing and pucking device(s) 206, loading device(s) 208, inspect device(s) 210, unit of use device(s) 212, automated dispensing device(s) 214, manual fulfillment device(s) 216, review devices 218, imaging device(s) 220, cap device(s) 222, accumulation devices 224, packing device(s) 226, literature device(s) 228, unit of use packing device(s) 230, and mail manifest device(s) 232. Further, the pharmacy fulfillment device 112 may include additional devices, which may communicate with each other directly or over the network 104.

In some implementations, operations performed by one of these devices 206-232 may be performed sequentially, or in parallel with the operations of another device as may be coordinated by the order processing device 114. In some implementations, the order processing device 114 tracks a prescription with the pharmacy based on operations performed by one or more of the devices 206-232.

In some implementations, the pharmacy fulfillment device 112 may transport prescription drug containers, for example, among the devices 206-232 in the high-volume fulfillment center, by use of pallets. The pallet sizing and pucking device 206 may configure pucks in a pallet. A pallet may be a transport structure for a number of prescription containers, and may include a number of cavities. A puck may be placed in one or more than one of the cavities in a pallet by the pallet sizing and pucking device 206. The puck may include a receptacle sized and shaped to receive a prescription container. Such containers may be supported by the pucks during carriage in the pallet. Different pucks may have differently sized and shaped receptacles to accommodate containers of differing sizes, as may be appropriate for different prescriptions.

The arrangement of pucks in a pallet may be determined by the order processing device 114 based on prescriptions that the order processing device 114 decides to launch. The arrangement logic may be implemented directly in the pallet sizing and pucking device 206.

Once a prescription is set to be launched, a puck suitable for the appropriate size of container for that prescription may be positioned in a pallet by a robotic arm or pickers. The pallet sizing and pucking device 206 may launch a pallet once pucks have been configured in the pallet.

The loading device 208 may load prescription containers into the pucks on a pallet by a robotic arm, a pick and place mechanism (also referred to as pickers), etc. In various implementations, the loading device 208 has robotic arms or pickers to grasp a prescription container and move it to and from a pallet or a puck. The loading device 208 may also print a label that is appropriate for a container that is to be loaded onto the pallet, and apply the label to the container. The pallet may be located on a conveyor assembly during these operations (e.g., at the high-volume fulfillment center, etc.).

The inspect device 210 may verify that containers in a pallet are correctly labeled and in the correct spot on the pallet. The inspect device 210 may scan the label on one or more containers on the pallet. Labels of containers may be scanned or imaged in full or in part by the inspect device 210. Such imaging may occur after the container has been lifted out of its puck by a robotic arm, picker, etc., or may be otherwise scanned or imaged while retained in the puck. In some implementations, images and/or video captured by the inspect device 210 may be stored in the storage device 110 as order data 118.

The unit of use device 212 may temporarily store, monitor, label, and/or dispense unit of use products. In general, unit of use products are prescription drug products that may be delivered to a user or member without being repackaged at the pharmacy. These products may include pills in a container, pills in a blister pack, inhalers, etc. Prescription drug products dispensed by the unit of use device 212 may be packaged individually or collectively for shipping, or may be shipped in combination with other prescription drugs dispensed by other devices in the high-volume fulfillment center.

At least some of the operations of the devices 206-232 may be directed by the order processing device 114. For example, the manual fulfillment device 216, the review device 218, the automated dispensing device 214, and/or the packing device 226, etc. may receive instructions provided by the order processing device 114.

The automated dispensing device 214 may include one or more devices that dispense prescription drugs or pharmaceuticals into prescription containers in accordance with one or multiple prescription orders. In general, the automated dispensing device 214 may include mechanical and electronic components with, in some implementations, software and/or logic to facilitate pharmaceutical dispensing that would otherwise be performed in a manual fashion by a pharmacist and/or pharmacist technician. For example, the automated dispensing device 214 may include high-volume fillers that fill a number of prescription drug types at a rapid rate and blister pack machines that dispense and pack drugs into a blister pack. Prescription drugs dispensed by the automated dispensing devices 214 may be packaged individually or collectively for shipping, or may be shipped in combination with other prescription drugs dispensed by other devices in the high-volume fulfillment center.

The manual fulfillment device 216 controls how prescriptions are manually fulfilled. For example, the manual fulfillment device 216 may receive or obtain a container and enable fulfillment of the container by a pharmacist or pharmacy technician. In some implementations, the manual fulfillment device 216 provides the filled container to another device in the pharmacy fulfillment devices 112 to be joined with other containers in a prescription order for a user or member.

In general, manual fulfillment may include operations at least partially performed by a pharmacist or a pharmacy technician. For example, a person may retrieve a supply of the prescribed drug, may make an observation, may count out a prescribed quantity of drugs and place them into a prescription container, etc. Some portions of the manual fulfillment process may be automated by use of a machine. For example, counting of capsules, tablets, or pills may be at least partially automated (such as through use of a pill counter). Prescription drugs dispensed by the manual fulfillment device 216 may be packaged individually or collectively for shipping, or may be shipped in combination with other prescription drugs dispensed by other devices in the high-volume fulfillment center.

The review device 218 may process prescription containers to be reviewed by a pharmacist for proper pill count, exception handling, prescription verification, etc. Fulfilled prescriptions may be manually reviewed and/or verified by a pharmacist, as may be required by state or local law. A pharmacist or other licensed pharmacy person who may dispense certain drugs in compliance with local and/or other laws may operate the review device 218 and visually inspect a prescription container that has been filled with a prescription drug. The pharmacist may review, verify, and/or evaluate drug quantity, drug strength, and/or drug interaction concerns, or otherwise perform pharmacist services. The pharmacist may also handle containers which have been flagged as an exception, such as containers with unreadable labels, containers for which the associated prescription order has been canceled, containers with defects, etc. In an example, the manual review can be performed at a manual review station.

The imaging device 220 may image containers once they have been filled with pharmaceuticals. The imaging device 220 may measure a fill height of the pharmaceuticals in the container based on the obtained image to determine if the container is filled to the correct height given the type of pharmaceutical and the number of pills in the prescription. Images of the pills in the container may also be obtained to detect the size of the pills themselves and markings thereon. The images may be transmitted to the order processing device 114 and/or stored in the storage device 110 as part of the order data 118.

The cap device 222 may be used to cap or otherwise seal a prescription container. In some implementations, the cap device 222 may secure a prescription container with a type of cap in accordance with a user preference (e.g., a preference regarding child resistance, etc.), a plan sponsor preference, a prescriber preference, etc. The cap device 222 may also etch a message into the cap, although this process may be performed by a subsequent device in the high-volume fulfillment center.

The accumulation device 224 accumulates various containers of prescription drugs in a prescription order. The accumulation device 224 may accumulate prescription containers from various devices or areas of the pharmacy. For example, the accumulation device 224 may accumulate prescription containers from the unit of use device 212, the automated dispensing device 214, the manual fulfillment device 216, and the review device 218. The accumulation device 224 may be used to group the prescription containers prior to shipment to the member.

The literature device 228 prints, or otherwise generates, literature to include with each prescription drug order. The literature may be printed on multiple sheets of substrates, such as paper, coated paper, printable polymers, or combinations of the above substrates. The literature printed by the literature device 228 may include information required to accompany the prescription drugs included in a prescription order, other information related to prescription drugs in the order, financial information associated with the order (for example, an invoice or an account statement), etc.

In some implementations, the literature device 228 folds or otherwise prepares the literature for inclusion with a prescription drug order (e.g., in a shipping container). In other implementations, the literature device 228 prints the literature and is separate from another device that prepares the printed literature for inclusion with a prescription order.

The packing device 226 packages the prescription order in preparation for shipping the order. The packing device 226 may box, bag, or otherwise package the fulfilled prescription order for delivery. The packing device 226 may further place inserts (e.g., literature or other papers, etc.) into the packaging received from the literature device 228. For example, bulk prescription orders may be shipped in a box, while other prescription orders may be shipped in a bag, which may be a wrap seal bag.

The packing device 226 may label the box or bag with an address and a recipient's name. The label may be printed and affixed to the bag or box, be printed directly onto the bag or box, or otherwise associated with the bag or box. The packing device 226 may sort the box or bag for mailing in an efficient manner (e.g., sort by delivery address, etc.). The packing device 226 may include ice or temperature sensitive elements for prescriptions that are to be kept within a temperature range during shipping (for example, this may be necessary in order to retain efficacy). The ultimate package may then be shipped through postal mail, through a mail order delivery service that ships via ground and/or air (e.g., UPS, FEDEX, or DHL, etc.), through a delivery service, through a locker box at a shipping site (e.g., AMAZON locker or a PO Box, etc.), or otherwise.

The unit of use packing device 230 packages a unit of use prescription order in preparation for shipping the order. The unit of use packing device 230 may include manual scanning of containers to be bagged for shipping to verify each container in the order. In an example implementation, the manual scanning may be performed at a manual scanning station.

The pharmacy fulfillment device 112 may also include a mail manifest device 232 to print mailing labels used by the packing device 226 and may print shipping manifests and packing lists.

While the pharmacy fulfillment device 112 in FIG. 2 is shown to include single devices 206-232, multiple devices may be used. When multiple devices are present, the multiple devices may be of the same device type or models, or may be a different device type or model.

The types of devices 206-232 shown in FIG. 2 are example devices. In other configurations of the system 100, lesser, additional, or different types of devices may be included.

Moreover, multiple devices may share processing and/or memory resources. The devices 206-232 may be located in the same area or in different locations. For example, the devices 206-232 may be located in a building or set of adjoining buildings. The devices 206-232 may be interconnected (such as by conveyors), networked, and/or otherwise in contact with one another or integrated with one another (e.g., at the high-volume fulfillment center, etc.). In addition, the functionality of a device may be split among a number of discrete devices and/or combined with other devices.

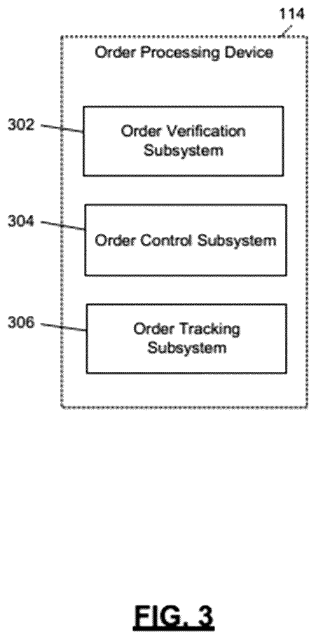

FIG. 3 illustrates the order processing device 114 according to an example implementation. The order processing device 114 may be used by one or more operators to generate prescription orders, make routing decisions, make prescription order consolidation decisions, track literature with the system 100, and/or view order status and other order related information. For example, the prescription order may include order related components.

The order processing device 114 may receive instructions to fulfill an order without operator intervention. An order component may include a prescription drug fulfilled by use of a container through the system 100. The order processing device 114 may include an order verification subsystem 302, an order control subsystem 304, and/or an order tracking subsystem 306. Other subsystems may also be included in the order processing device 114.

The order verification subsystem 302 may communicate with the benefit manager device 102 to verify the eligibility of the member and review the formulary to determine appropriate copayment, coinsurance, and deductible for the prescription drug and/or perform a DUR (drug utilization review). Other communications between the order verification subsystem 302 and the benefit manager device 102 may be performed for a variety of purposes.

The order control subsystem 304 controls various movements of the containers and/or pallets along with various filling functions during their progression through the system 100. In some implementations, the order control subsystem 304 may identify the prescribed drug in one or more than one prescription orders as capable of being fulfilled by the automated dispensing device 214. The order control subsystem 304 may determine which prescriptions are to be launched and may determine that a pallet of automated-fill containers is to be launched.

The order control subsystem 304 may determine that an automated-fill prescription of a specific pharmaceutical is to be launched and may examine a queue of orders awaiting fulfillment for other prescription orders, which will be filled with the same pharmaceutical. The order control subsystem 304 may then launch orders with similar automated-fill pharmaceutical needs together in a pallet to the automated dispensing device 214. As the devices 206-232 may be interconnected by a system of conveyors or other container movement systems, the order control subsystem 304 may control various conveyors: for example, to deliver the pallet from the loading device 208 to the manual fulfillment device 216 from the literature device 228, paperwork as needed to fill the prescription.

The order tracking subsystem 306 may track a prescription order during its progress toward fulfillment. The order tracking subsystem 306 may track, record, and/or update order history, order status, etc. The order tracking subsystem 306 may store data locally (for example, in a memory) or as a portion of the order data 118 stored in the storage device 110.

Referring again to FIG. 1, the various components of illustrated in the system 100 can include numerous infrastructure elements (hardware and software assets) that can provide technical services for end users. The technical services can include application services used for business purposes or other work performed by an organization. Moreover, an IT team can deploy the infrastructure elements as needed to meet end user demands. For example, as described above, the benefit manager device 102 can receive prescription drug claims and adjudicate those claims according to defined processes. An application service can perform the claim adjudication service by implementing numerous infrastructure elements offered as a technical service. In this example, the infrastructure elements necessary to perform this technical service can involve numerous network paths, network elements (switches, paths, routers, etc.), servers (Unix, mainframes, midrange servers), database or storage elements, etc. In addition, the infrastructure elements can include regionality items for resiliency, such as a number of redundant servers located in a plurality of different regions across a geographical area. The adjudication application service may utilize many of these infrastructure objects to perform a compute technical service that determines the adjudication result. The adjudication application service may also rely on numerous database architectures or Redis cache technical services to receive the data objects, such as the order data 118, the member data 120, the claims data 122, the drug data 124, the prescription data 126, and/or the plan sponsor data 128 necessary and reference these data as part of the adjudication application service. Moreover, the adjudication application service may require database or cache technical services to store adjudication results or intermediate results generated as part of the adjudication process prior to a final decision by the benefit manager device 102.

While business services provided by the system 100 may occupy many or all of the infrastructure objects of the system 100, some of the infrastructure objects may be unused or in standby. When those elements are unused, they can be deployed later to an end user or sold to a customer in need of a technical service offering. To track and manage the infrastructure elements of the system 100, the benefit manager device 102 may implement a configuration management database (“CMDB”) that can store information about the infrastructure elements (i.e., “configuration items” or “CI”). The CMDB can also store relationships between the CIs as metadata, such as the dependency of some CIs on other CIs upstream or downstream.

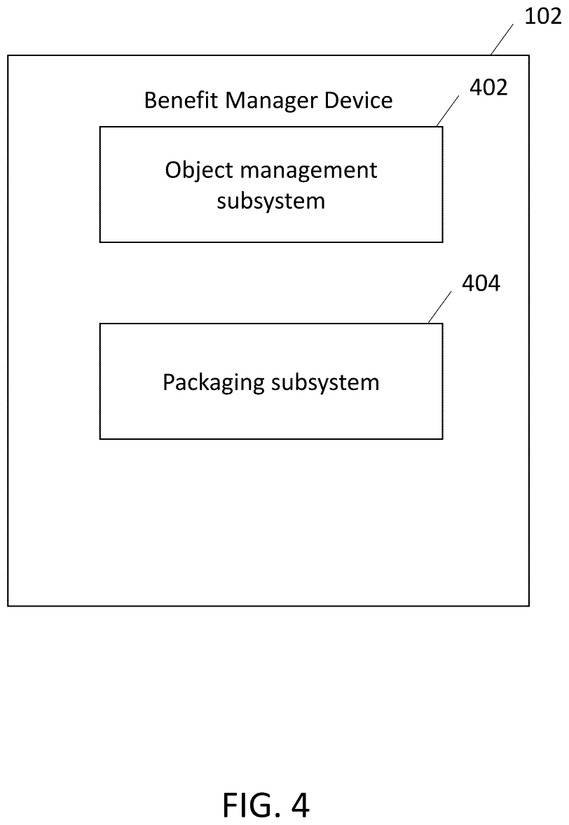

FIG. 4 illustrates the benefit manager device 102, according to an example embodiment. The benefit manager device 102 may be deployed in the system 100, or may otherwise be used. The benefit manager device 102 may include an object management subsystem 402 and a packaging subsystem 404.

According to an exemplary embodiment, the object management subsystem 402 can include an inventory of some or all of the infrastructure objects owned or controlled by an entity. In some embodiments, the object management subsystem 402 can act as a CMDB. The object management subsystem 402 can store all the infrastructure objects as CIs in the CMDB. In addition, the object management subsystem 402 can store relationships between some or all of the CIs stored in the CMBD. In some embodiments, the relationships between CIs are stored as metadata in the CMDB.

The CIs can represent infrastructure units within a system. The CIs can be data objects that represent various infrastructure elements in the system 100, such as hardware or devices, software or applications, networks, network components/elements, locations, databases, facilities, and services. The data objects comprising the CIs can store various data about the infrastructure elements, including a unique identifier, a name, a description, CI ownership, and CI relationship to other CIs. The data object can also store each CIs position within hierarchy, architecture, or logical layers.

In addition to storing the CIs in the CMDB, the object management subsystem 402 can track whether each CI in the CMDB is active or inactive. In other words, the object management subsystem 402 can determine whether each CI in the CMDB is actively being used for a technical service or available for use in a technical service. In addition, the object management subsystem 402 can track unused infrastructure assets not yet stored as CIs in the CMDB. The object management subsystem 402 can provide the list of all or some of the CIs to the packaging subsystem 404. In some embodiments, the object management subsystem 402 can provide the list of available CIs available for a technical service offering.

According to an exemplary embodiment, the packaging subsystem 404 can create an infrastructure service instance (“ISI”) data object by grouping all infrastructure objects that initiate an instance of a particular technical service offering. The packaging subsystem 404 can create the ISI data object that identifies a technical service offering, a resiliency level, and all infrastructure objects that instantiate the instance of the technical service offering. In some embodiments, the packaging subsystem 404 can associate one or more CIs with the ISI data object. In some embodiments, the resiliency level of the ISI data object can be associated with an SLA or an SLO.

The packaging subsystem 404 can create a plurality of ISIs associated with a technical service offering associated with each of a plurality of resiliency levels. For example, an organization can offer four resiliency tiers associated with four different SLOs (e.g., “bronze tier” offering 99% guaranteed uptime; “silver tier” offering 99.9% guaranteed uptime; “gold tier” offering 99.99% guaranteed uptime; or “platinum tier” offering 99.999% guaranteed uptime).

Each resiliency tier can identify a number of additional or different infrastructure objects to meet the SLO indicated by the resiliency tier. For example, a “bronze” resiliency tier (e.g., 99% guaranteed uptime) Redis cache ISI data object can identify a single network path to a single database, whereas a “silver resiliency tier” (99.9% guaranteed uptime) Redis cache ISI data object can identify two network paths to two, separate databases. In some embodiments, the two, separate databases may be located in different geographical regions to provided added resiliency. A “gold” resiliency tier (99.99% guaranteed uptime) or a “platinum” resiliency tier (99.999% guaranteed uptime) may identify additional databases CIs, additional network paths, and additional regions.

The packaging subsystem 404 can further identify signal CI objects that can assist with monitoring the technical service offering and ensuring that the technical service offering is healthy and meeting SLO requirements.

Thus, the packaging subsystem 404 can create an ISI data object by creating a table that lists the technical service offered, all the CIs or infrastructure objects necessary to deploy the technical service offering, the level of resiliency (which may be an SLO), and any signals for monitoring the health of the technical service offering. In some embodiments, the ISI data object can further identify an application service implemented as part of the technical service offering.

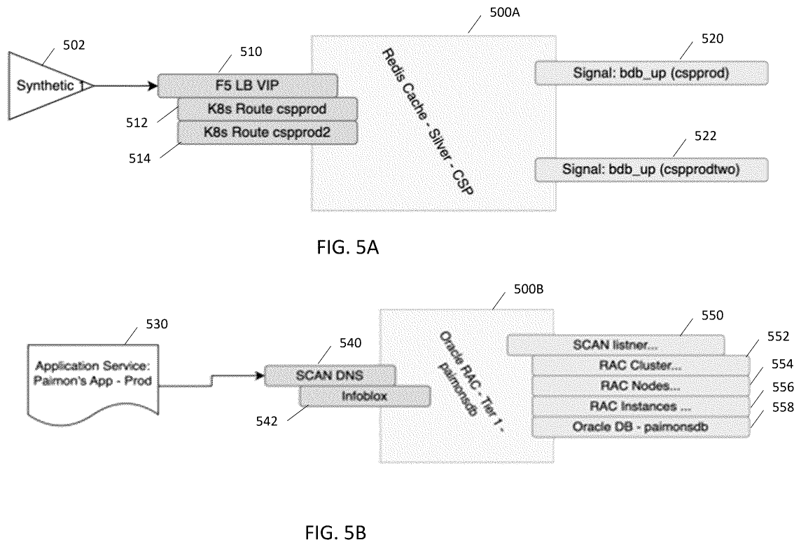

FIG. 5A illustrates an exemplary ISI data object for a silver tier Redis cache. As shown in FIG. 5A, a silver tier Redis cache ISI data object 500A can include an application service 502, a plurality of CIs 510-514, and a plurality of signals 520-522 for monitoring the health of the Redis cache. In the example shown in FIG. 5A, the plurality of CIs 510-514 can include a cache or set of memory or storage 510, first network route 512, and a second network route 514. Furthermore, in the example shown in FIG. 5A, the plurality of signals can include a first production signal 520 and a second production signal 522 monitoring the Redis cache under a first and second production condition of the Redis cache. According to an exemplary embodiment, the first production signal 520 can report health or errors under the first production condition, and the second production signal 522 can report health or errors under the second production condition.

FIG. 5B illustrates an exemplary ISI data object for a bronze tier Oracle Real Application Cluster (“RAC”) database. As shown in FIG. 5B, a bronze tier Oracle RAC ISI data object 500A can include an application service 530, a plurality of CIs 540-542, and a plurality of signals 550-558 for monitoring the health of the Oracle RAC. In the example shown in FIG. 5B, the plurality of CIs 540-542 can include a single client access name (“SCAN”) domain name system (“DNS”) (i.e., a nameserver) 540, and networking services 542 (e.g., Infoblox networking services to interface with the SCAN DNS). Furthermore, in the example shown in FIG. 5B, the plurality of signals can include a SCAN signal 550, a RAC cluster signal 552, a RAC nodes signal 554, a RAC instances signal 556, and an Oracle database signal 558. Each of these signals 550-558 can monitor an aspect of the RAC database and provide health data about each subcomponent of the RAC database.

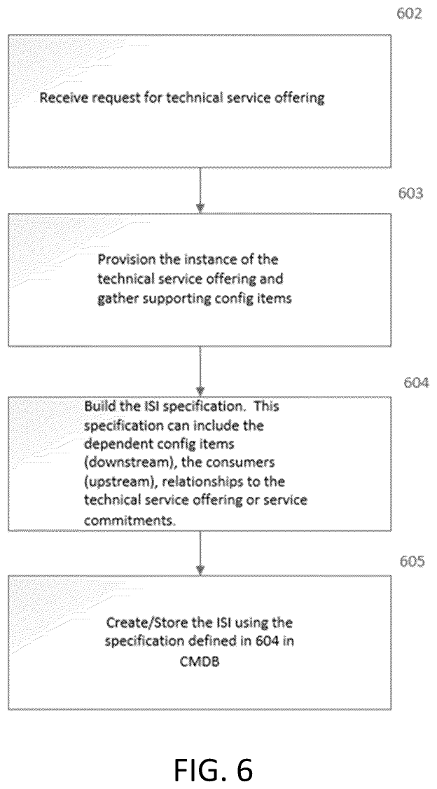

FIG. 6 illustrates a method 600 for automating the creation of a technical service offering using an infrastructure service instance data object according to an example embodiment. The method 600 may be performed by the benefit manager device 102, partially by the benefit manager device 102 and partially by the pharmacy device 106, or may be otherwise performed. For the sake of simplicity, the benefit manager device 102 will be described as performing the steps of the method 600, but the embodiments described herein are not so limited.

According to an exemplary embodiment, the benefit manager device 102 can receive a request for a technical service offering in step 602. The technical service offering can include a resiliency level, which can comprise an SLO. In response to the request, the benefit manager device 102 can provision an instance of the technical service offering and gather supporting configuration items in step 603. In some embodiments, the technical service offering may be requested to implement a specific application service. The application service may include certain requirements, including resiliency requirements, and infrastructure requirements (e.g., database, database type, compute, etc.). The benefit manager device 102 can reference the object management subsystem 404 or a CMDB to determine available infrastructure assets and configuration items that fits the requirements of the technical service offering request or whether a new infrastructure instance must be instantiated to meet the requirements of the technical service request. When a new ISI data object is to be created, the benefit manager device 102 can build the ISI data object according to a specification in step 604. The benefit manager device 102 can create the ISI data object, thereby creating an infrastructure instance used to generate a technical service offering, by creating databases, network connections, virtual machines, server instances, or any other infrastructure asset. In addition, the benefit manager device 102 can create the ISI data object by identifying dependent configuration items, which are sometimes called downstream configuration items, consumers of the technical service, which are sometimes called upstream configuration items, and relationships to the technical service offering or service commitment. In some embodiments, the ISI data object can include generic identifications of infrastructure types prior to finalization in step 606. For example, the ISI data object for a Redis cache may include a database object and a network path, but the specific network path (e.g., IP address or the like) and a specific database location (e.g., address in memory, etc.) is blank. After creating or identifying specific infrastructure elements, the benefit manager device 102 can store those specific infrastructure elements as CIs in the ISI data object. Subsequently, the benefit manager device 102 can store the ISI data object, which includes all the identified infrastructure objects/CIs and which was created in step 604, to the CMDB in step 605.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A. The term subset does not necessarily require a proper subset. In other words, a first subset of a first set may be coextensive with (equal to) the first set.

In this application, including the definitions below, the term “module” or the term “controller” may be replaced with the term “circuit.” The term “module” may refer to, be part of, or include processor hardware (shared, dedicated, or group) that executes code and memory hardware (shared, dedicated, or group) that stores code executed by the processor hardware.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2016 (also known as the WIFI wireless networking standard) and IEEE Standard 802.3-2015 (also known as the ETHERNET wired networking standard). Examples of a WPAN are the BLUETOOTH wireless networking standard from the Bluetooth Special Interest Group and IEEE Standard 802.15.4.

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor (i.e., circuitry) that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer (e.g., arranged circuitry) created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

Example methods and systems for using machine learning algorithms are described. In the following description, for purposes of explanation, numerous specific details are set forth in order to provide a thorough understanding of example embodiments. It will be evident, however, to one of ordinary skill in the art that embodiments of the present disclosure may be practiced without these specific details.

1. A method comprising:
a packaging subsystem receiving a request for a technical service offering;
the packaging subsystem creating an infrastructure service instance (“ISI”) data object associated with the technical service offering, wherein the ISI data object includes at least one infrastructure object identifying at least one infrastructure asset necessary to provide a technical service, a resiliency level, and one or more monitoring signals configured to indicate the health of the at least one of infrastructure asset;
the packaging subsystem communicating with an object management subsystem to determine available infrastructure assets monitored by the object management subsystem;
the packaging subsystem creating at least one infrastructure instance specified by the at least one infrastructure object of the ISI data object, wherein the infrastructure instance includes an identifier;
the packaging subsystem associating the at least one created infrastructure instance with the at least one infrastructure object in the ISI data object, wherein the at least one infrastructure object includes the identifier after associating the at least one infrastructure object with the at least one infrastructure instance; and
the packaging subsystem storing the ISI data object in a configuration management data base (“CMDB”).

2. The method of claim 1, wherein the resiliency level is a service level objective.

3. The method of claim 2, wherein the service level objective at least indicates a percentage of guaranteed uptime for the technical service.

4. The method of claim 1, wherein higher resiliency levels include multiple network paths and redundant databases or servers placed in separate geographic regions.

5. The method of claim 1, wherein the ISI data object includes one monitoring signal for each infrastructure object associated with the ISI data object.

6. The method of claim 1, wherein the object management subsystem stores the CMDB.

7. The method of claim 1, wherein the ISI data object includes supporting configuration items, and wherein the ISI data object further includes dependent configuration items, consumers, and relationships to the technical service offering or service commitment.

8. The method of claim 1, wherein the packaging subsystem creating the at least one infrastructure instance comprises the packaging subsystem creating a database.

9. The method of claim 1, wherein the packaging subsystem creating the at least one infrastructure instance comprises the packaging subsystem creating a compute server.

10. The method of claim 1, wherein the packaging subsystem creating the at least one infrastructure instance comprises the packaging subsystem creating a network path.

11. A system for automatic processing prescription, comprising:
a storage device configured to store at least one infrastructure service instance (“ISI”) data object associated with a technical service offering and available infrastructure assets monitored by an object management subsystem, wherein the ISI data object includes at least one infrastructure object identifying at least one infrastructure asset necessary to provide a technical service, a resiliency level, and one or more monitoring signals configured to indicate the health of the at least one of infrastructure asset;
a packaging subsystem in communication with the storage device and configured to:
receive a request for the technical service offering;
reference the at least one ISI data object;
communicate with the object management subsystem to determine the available infrastructure assets;
create at least one infrastructure instance specified by the at least one infrastructure object of the ISI data object, wherein the infrastructure instance includes an identifier;
associate the at least one created infrastructure instance with the at least one infrastructure object in the ISI data object, wherein the at least one infrastructure object includes the identifier after associating the at least one infrastructure object with the at least one infrastructure instance; and
store the ISI data object in a configuration management data base (“CMDB”).

12. The system of claim 11, wherein the resiliency level is a service level objective.

13. The system of claim 12, wherein the service level objective at least indicates a percentage of guaranteed uptime for the technical service.

14. The system of claim 11, wherein higher resiliency levels include multiple network paths and redundant databases or servers placed in separate geographic regions.

15. The system of claim 11, wherein the ISI data object includes one monitoring signal for each infrastructure object associated with the ISI data object.

16. The system of claim 11, wherein the object management subsystem stores the CMDB.

17. The system of claim 11, wherein the ISI data object includes supporting configuration items, and wherein the ISI data object further includes dependent configuration items, consumers, and relationships to the technical service offering or service commitment.

18. The system of claim 11, wherein the packaging subsystem is further configured to create a database.

19. The system of claim 11, wherein the packaging subsystem is further configured to create a compute server.

20. A non-transitory computer-readable medium storing processor-executable instructions, the instructions comprising:
receive a request for a technical service offering;
reference an infrastructure service instance (“ISI”) data object associated with the technical service offering, wherein the ISI data object includes at least one infrastructure object identifying at least one infrastructure asset necessary to provide a technical service, a resiliency level, and one or more monitoring signals configured to indicate the health of the at least one of infrastructure asset;
communicate with an object management subsystem to determine available infrastructure assets monitored by the object management subsystem;
create at least one infrastructure instance specified by the at least one infrastructure object of the ISI data object, wherein the infrastructure instance includes an identifier;
associate the at least one created infrastructure instance with the at least one infrastructure object in the ISI data object, wherein the at least one infrastructure object includes the identifier after associating the at least one infrastructure object with the at least one infrastructure instance; and
store the ISI data object in a configuration management data base (“CMDB”).
